(19) United States
(12) Patent Application Publication
(10) Pub. No.: US 2006/0248260 A1
(43) Pub. Date: Nov. 2, 2006

(54) Circuit system

(76) Inventors: Maksim Kuzmenka, Munich (DE); Simon Muff, Mering (DE); Hermann Ruckerbauer, Moos (DE)

Correspondence Address: SLATER & MATSIL LLP, 17950 PRESTON ROAD, SUITE 1000, DALLAS, TX, 75252, US

(21) Appl. No.: 11/392,217

(22) Filed: Mar. 29, 2006

Related U.S. Application Data
(63) Continuation of application No. PCT/EP04/09061, filed on Aug. 12, 2004.

(30) Foreign Application Priority Data
Sep. 30, 2003 (DE) 103 45 384.9

(51) Int. Cl. G06F 12/02

(52) U.S. Cl. 711/1

(57) ABSTRACT

A circuit system includes a means for controlling a first and a second memory unit by means of a differential control signal. The differential control signal includes a first control signal and a second control signal, which is inverted to the first control signal. Further, the circuit system comprises a differential control signal line, which includes a first signal line for routing the first control signal and a second signal line for routing the second control signal. The first switching unit is connected via the first signal line and the second circuit unit is connected via the second signal line to the means for controlling.

This application is a continuation of copending International Application No. PCT/EP2004/009061, filed Aug. 12, 2004, which designated the United States and was not published in English, and which is based on German Application No. 103 45 384.9, filed Sep. 30, 2003, both of which application are incorporated herein by reference in their entirety.

### TECHNICAL FIELD

The present invention relates to a circuit system, and in particular to a circuit system having two circuit units which are controlled by control signals which are inverted to each other.

### BACKGROUND

Circuit systems frequently comprise signals connected to several circuit units. These signals are strongly capacitively loaded. This problem in particular occurs in computer memory systems.

In current DDR1 and DDR2 (DDR=double data rate) computer storage systems, “unbuffered DIMMs” (DIMM=dual in-line memory module) are used. In those systems, in particular the command/address bus is very strongly capacitively loaded. On one DIMM up to 18 DRAM devices are arranged, which are either directly, or via a hybrid T topology, connected to a command/address bus line, which is driven by a memory control unit. A DDR2 memory system comprises approximately 27 CA signals (CA=command/address). By the strong capacitive load the signal quality on the corresponding signal line deteriorates. In order to achieve a good signal quality on the DIMM in spite of this, a certain ratio of signal lines to ground lines is required. The ratio of CA signals to ground signals on a DIMM is usually 2:1. Apart from the CA signals, a CA bus therefore comprises a plurality of ground signals. This increases the line number of a CA bus to usually approximately 40 signal and ground lines.

FIG. 4 shows a computer memory system according to the prior art. A memory control means 402, in the form of a “controller”, controls a plurality of memory devices 404 in the form of DRAMs. The memory devices 404 are arranged on a memory module 412 in the form of an “unbuffered DIMM”. The memory devices 404 are connected to the memory controller 402 via a memory bus. For reasons of clarity, in FIG. 4 only one single CA signal 420 of the memory bus is shown.

On the memory module 412, the CA signal 420 comprises a T topology. The memory devices 404 are connected to the CA signal 420 via contact locations 430. Open ends of the CA signal 420 are terminated on the memory module 412 by line terminations 432.

Both the memory controller 402 and also the memory module 412 are conventionally arranged on a motherboard (not shown) of a computer system. The memory controller 402 is hereby usually part of a chip set (not shown). The memory module 412 conventionally comprises up to 18 memory devices 404 of which, for reasons of clarity, only four are shown. As all memory devices 404 are controlled by the CA signal 420, the CA signal 420 is substantially capacitively loaded. Thus, the signal integrity of the CA signal 420 is a big problem, as the data rate possible on the CA signal 420 is negatively influenced.

FIG. 5 shows a possibility for improving the signal integrity in a memory means according to the prior art. By this, the data rate in the memory means may be increased. According to FIG. 4, the memory system in FIG. 5 comprises a memory controller 502 and a plurality of memory devices 504, 506 arranged on a memory module 512. In this embodiment, the memory devices 504, 506 are separated into first memory devices 504 and second memory devices 506.

For controlling the first and second memory devices 504, 506, the present embodiment comprises two identical copies of a CA bus. For reasons of clarity, again only two individual CA signal lines 522, 524 of the two CA buses are shown. A first CA signal is driven from the memory controller 502 via a first CA signal line 522 to the first memory devices 504. A second CA signal is driven from the memory controller 502 via a second CA signal line 524 to the second memory devices 506. The memory devices 504, 506 are connected to the first and the second CA signal lines 522, 524 via contact locations 530. Free ends of the CA signal lines 522, 524 are each provided with a line termination 532.

The signal integrity of the first and the second CA signal lines 522, 524 is substantially better in this embodiment than in the embodiment shown in FIG. 4, as the capacitive load on the CA signal lines 522, 524 is halved. This enables a higher transmission rate on the CA signal lines 522, 524.

It is a substantial disadvantage of this embodiment, that the number of CA signal lines 522, 524 is doubled as compared to the embodiment shown in FIG. 4. This results in a very strong increase in the number of pins of a plug (not shown) connecting the memory module 512 to the motherboard (not shown). This additionally complicates a signal line routing on the motherboard. The signal routing is problematic as the available area in which the signals may be routed is limited and a cross talk between the signals has to be prevented. This becomes even more complicated as all CA receivers simultaneously switch into one direction, whereby additionally potential interferences are caused, for example on a reference voltage.

The doubling of the CA signals in particular also results in a doubling of the ground signals, as the ratio of ground signals to CA signals remains the same.

### SUMMARY OF THE INVENTION

It is an object of the present invention to provide a circuit system comprising a high signal integrity with a low number of control signals and thereby enabling a high data transmission rate.

The present invention provides a circuit system, having a controller for controlling a first circuit unit and a second circuit unit by means of a differential control signal, wherein the differential control signal comprises a first control signal and a second control signal which is inverted to the first control signal; a differential control signal line comprising a first signal line for routing the first control signal and a second signal line for routing the second control signal; and wherein the first circuit unit is connected via the first signal line and not the second signal line, and the second circuit unit is connected via the second signal line and not the first signal line, to the controller for controlling.

The present invention is based on the finding that the characteristics of a differential signal may advantageously be used in a circuit system in which several circuit units are controlled by the same signal.

According to the present invention, a means for controlling provides a differential control signal whose first control signal line is used for controlling a first circuit unit and whose second control signal line is used for controlling a second circuit unit. One advantage of the differential implementation of the control signals is that a current feedback path of each of the control signal lines is routed on the associated complementary control signal line. By this, a signal-to-ground ratio may be reduced substantially. With an ideal differential line pair, no ground lines are required. A further advantage is an improved signal integrity, as on a differential line a risk due to cross talk is reduced. If a plurality of control lines is routed next to each other, then in the line routing a cross talk has to be considered only regarding half of the control signal lines.

### BRIEF DESCRIPTION OF THE DRAWINGS

Preferred embodiments of the present invention will be detailed subsequently referring to the appended drawings, in which:

FIG. 1 shows a block diagram of a circuit system according to the present invention;

FIG. 1A shows a schematic illustration of a differential control signal;

FIG. 2 shows a preferred embodiment of a memory system according to the present invention;

FIG. 3 shows a circuit system in the form of a memory system according to a further preferred embodiment of the present invention;

FIG. 4 shows a memory system according to the prior art; and

FIG. 5 shows a further embodiment of a memory system according to the prior art.

### DESCRIPTION OF THE PREFERRED EMBODIMENTS

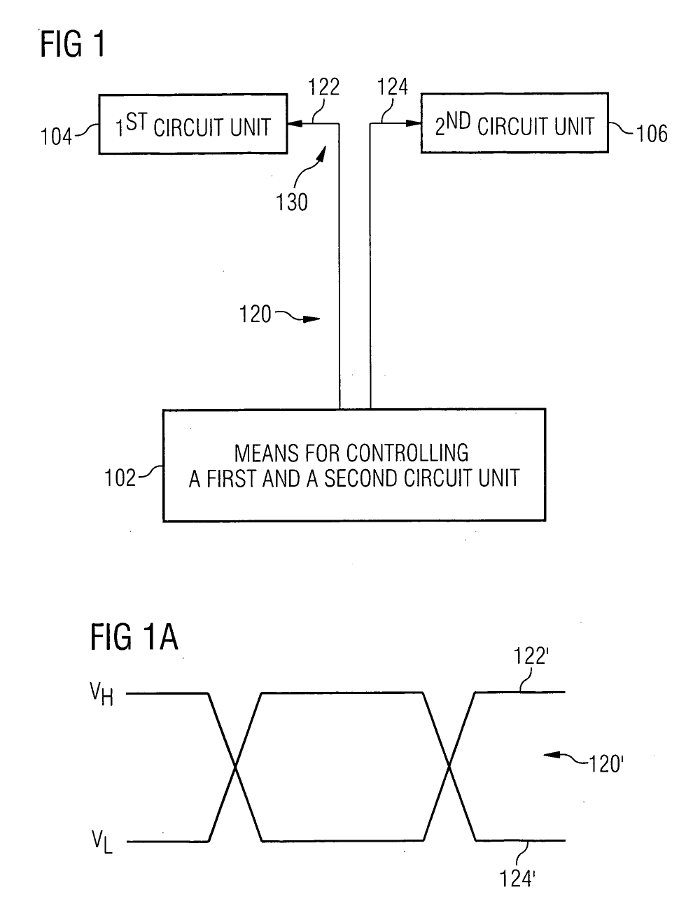

FIG. 1 shows a block diagram of a circuit system according to the present invention. The circuit system comprises a means 102 for controlling a first and a second circuit unit, and a first circuit unit 104, and a second circuit unit 106. The means 102 for controlling provides a differential control signal on a differential control signal line 120. The differential control signal line 120 comprises a first control signal line 122 and a second control signal line 124. The first control signal line 122 connects the means 102 for controlling to the first circuit unit 104 and the second control signal line 124 connects the means 102 for controlling to the second circuit unit 106.

In this embodiment, the means 102 for controlling and the circuit units 104, 106 are integrated circuits arranged on a printed circuit board (not shown). The first control signal line 122 and the second control signal line 124 of the differential control signal line 120 are routed on the printed circuit board as close as possible to each other and in parallel in order to prevent an interfering cross talk on the printed circuit board. A branching 130 of the control signal lines 122, 124 is arranged as close as possible to the circuit units 104, 106.

FIG. 1A shows a signal course of a differential control signal 120′ on a differential control signal line as it is shown in FIG. 1. The differential control signal 120′ comprises a first control signal 122′ and a second control signal 124′ which is inverted to the first control signal 122′. The control signals 122′, 124′ alternate between a top voltage potential V_{H} and a bottom voltage potential V_{L}. If the first control signal 122′ is at the voltage potential V_{H}, then the complementary second control signal 124′ is at the low voltage potential V_{L}. With an ideal differential signal, the voltage potentials V_{H} and V_{L} are equal regarding their amount, have different signs, however. In this case, the ideal differential signal does not require a ground terminal, as the respective complementary signal line guarantees a feedback of the signal current.

With a non-ideal differential signal, i.e., a signal shifted with regard to the 0 V level, a feedback of a signal current is required via an additional ground line (not shown). The signal current to be fed back is substantially lower, however, than in a non-differential signal implementation. By this, in a bus system the ratio of signal lines to ground lines is improved in favor of a reduction of the ground lines.

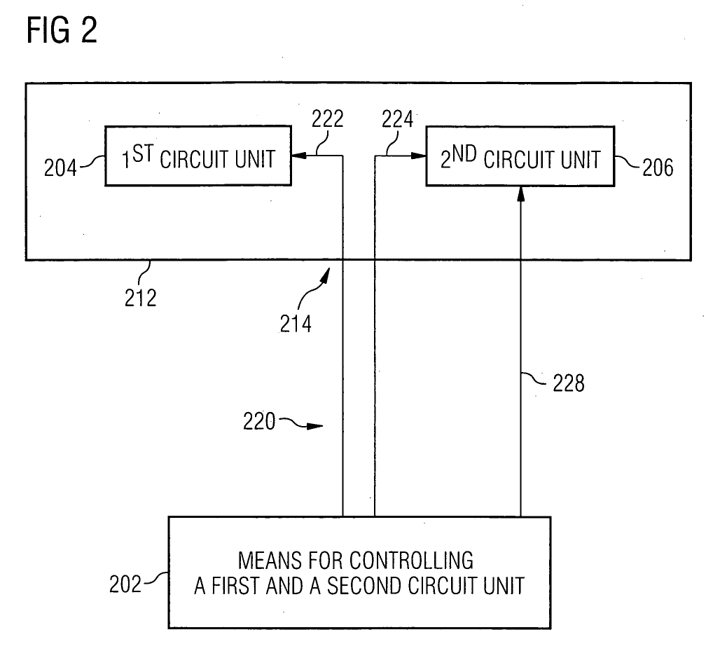

FIG. 2 shows a further preferred embodiment of a memory system according to the present invention. According to the embodiment shown in FIG. 1, the circuit system shown in FIG. 2 comprises a means 202 for controlling a first and a second circuit unit, and a first circuit unit 204, and a second circuit unit 206. The means 202 for controlling is connected to the first circuit unit 204 and the second circuit unit 206 via a differential control signal line 220 which comprises a first control signal line 222 and a second control signal line 224. Here, the first circuit unit 204 is again connected via the first control signal line 222, and the second circuit unit 206 is connected via the second control signal line 224, to the means 202 for controlling.

In this embodiment, the circuit units 204, 206 are arranged on a circuit module 212. The circuit module 212 comprises a differential input 214. Via this differential input 214, the memory module 212 is connected to the means for controlling a first and a second circuit unit via the differential control signal line 220.

The second circuit unit 206 comprises a means 228 for adjusting to an inverted control signal, in this embodiment the second control signal line 224. The means 228 is implemented as a signal which is provided by the means 202 for controlling. The second circuit unit 206 is implemented to adjust to the inverted control signal 224 of the differential control signal line 220 in response to the signal 228.

As an alternative to the signal 228, it is also possible, after splitting up the differential control signal into the first control signal and the second control signal, to arrange an inverter in the second control signal line. A further alternative possibility is an arrangement of an inverter in the second circuit unit.

In one memory system, which uses MRS commands (MRS=mode register set), there is a further possibility to determine whether a control line is inverted or not. When initializing a memory system in the form of a DRAM, an MRS command is transmitted. Here, the control signals are used in the form of address signals in order to set the MRS registers. Not all address signals are used, however. Thus, one or two address signals may be used in order to determine whether an inverse control signal bus is present or not. Conventionally, a “1” on the address signal A12 during the MRS command indicates that the bus is inverted.

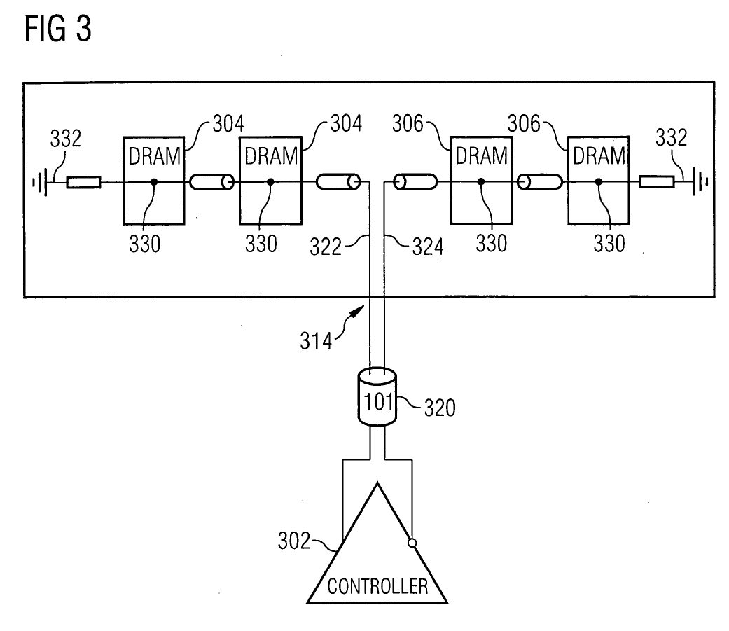

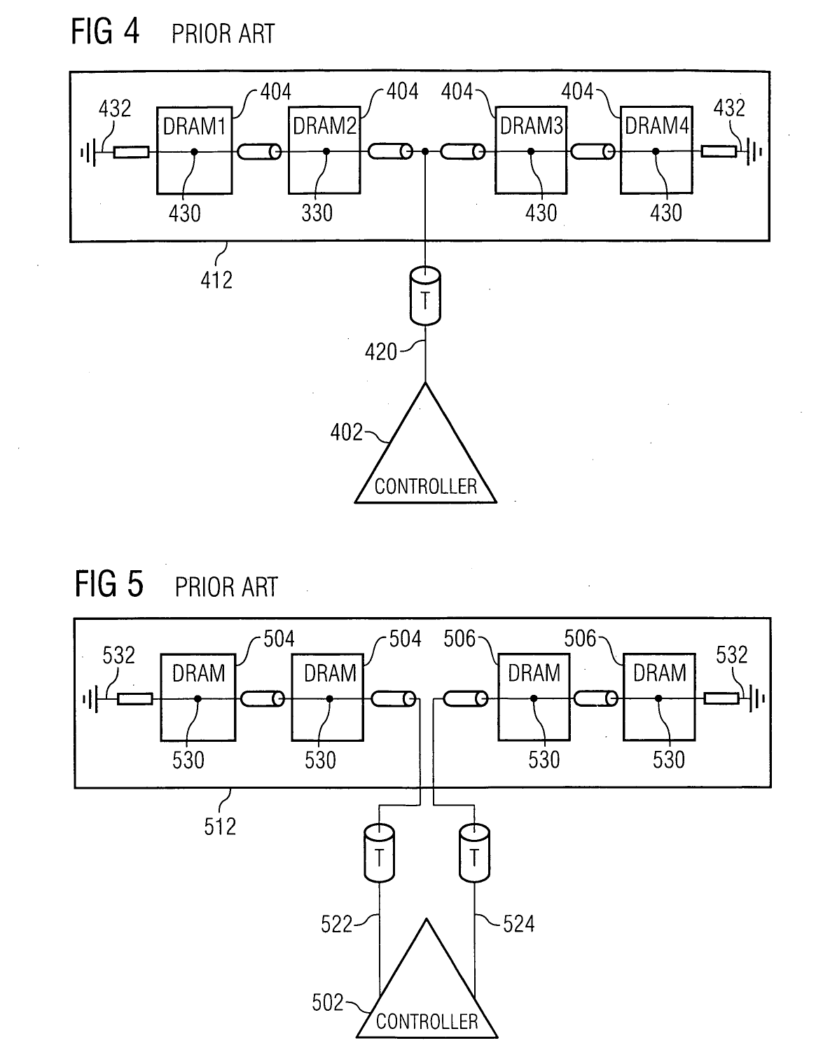

FIG. 3 shows a further preferred embodiment of the inventive circuit system in the form of a memory system. The memory system comprises a memory controller 302 controlling a plurality of memory devices 304, 306. The memory devices 304, 306 in the form of DRAMs are arranged on a memory module 312 in the form of an “unbuffered DIMM”. The memory module 312 may be a DDR1, DDR2 or DDR3 memory module. The memory module 312 comprises a differential input 314 via which the memory module 312 is connected to the memory controller 302 via a differential control signal 320. The differential control signal 320 comprises a first control signal 322 and a second control signal 324. Via the first control signal 322, the memory controller 302 is connected to the first memory devices 304. Via the second control signal 324, the memory controller 302 is connected to the second memory devices 306. The memory devices 304, 306 are connected to the control signal lines 322, 324 via contact locations 330. The control signal lines 322, 324 are terminated via line terminations 332 at their free ends.

The memory system presents a DDR1, DDR2, or DDR3 memory system. The memory controller 302, which is part of a chip set, and the memory module 312 are arranged on a motherboard (not shown). The memory module 312 typically comprises up to 18 memory devices 304, 306. The memory devices 304, 306 are connected to the memory controller 302 via a memory bus. For reasons of clarity, in FIG. 3 only four memory devices and only one CA signal of the memory bus are shown. The inventive approach of a differential CA control signal line enables a reduction of the ground signal lines required on the memory module 312. In contrast to the embodiment according to the prior art shown in FIG. 5, whose CA bus includes 80 signals including ground signal lines, for the inventive embodiment of FIG. 3 only two times 27 signals are required for the CA bus.

An inversion of the second control signal 324 has no influence on an addressing of the second memory devices 306, as a memory field of the second memory devices 306 is only written to and read out from another direction. An inversion of the address signals has effects on a mode register set (not shown) of the second memory devices 306, however, in which during an initialization phase functionality settings are performed. After an initialization of the memory devices 304, 306, the mode register set is adjusted. Here, an inversion of the second control signal 324 has to be considered, by switching off the inversion during writing a mode register set command, or by informing the second memory device 306 via a signal (shown in FIG. 2), whether it is addressed invertedly or normally, or whether the above indicated solution is used with an address signal, like the address signal A12.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. A circuit system comprising:
a controller coupled to a first circuit unit and a second circuit unit by means of a differential control signal, wherein the differential control signal comprises a first control signal and a second control signal that is inverted to the first control signal; and
a differential control signal line comprising a first signal line for routing the first control signal and a second signal line for routing the second control signal;
wherein the first circuit unit is coupled to the controller via the first signal line and not the second signal line, and the second circuit unit is coupled to the controller via the second signal line and not the first signal line.

2. The circuit system according to claim 1, wherein the first circuit unit and the second circuit unit are arranged on a circuit module comprising a differential input for connecting the circuit module to the differential control signal line.

3. The circuit system according to claim 1, wherein the second circuit unit comprises an adjuster for adjusting to the second control signal.

4. The circuit system according to claim 1, comprising an inverter for inverting the second control signal, which is connected to the second circuit unit, and providing an inverted second control signal to the second circuit unit.

5. The circuit system according to claim 1, wherein the circuit module comprises a memory module and the first and the second circuit units comprise a first and a second memory unit.

6. The circuit system according to claim 5, wherein the differential control signal comprise a command/address bus signal.

7. A memory system comprising:
a first memory chip;
a second memory chip; and
a controller coupled to the first memory chip and the second memory chip via a differential signal line that includes a first signal line and a second signal line, such that the first memory chip is coupled to the controller via the first signal line but not the second signal line and the second memory chip is coupled to the controller via the second signal line but not the first signal line.

8. The system of claim 7, wherein the differential signal line comprises a line of a command/address bus.

9. The system of claim 7, wherein the second memory chip comprises a means for adjusting a signal from the second signal line.

10. The system of claim 9, wherein the means for adjusting includes an external pin.

11. The system of claim 9, wherein the means for adjusting includes a register.

12. The system of claim 9, wherein the means for adjusting includes an inverter.

13. The system of claim 7, further comprising an inverter coupled between the controller and the second memory chip.

14. The system of claim 7, wherein the first and second memory chips are part of a double data rate DRAM DIMM.

15. The system of claim 14, wherein the DIMM comprises an unbuffered DIMM.

16. A memory device comprising:
a control input coupled to receive a control signal; and
means for determining if the control signal is an inverted control signal and for inverting the control signal if the control signal is an inverted control signal.

17. The device of claim 16, wherein the means comprises an input that carries a signal indicating that the control signal is an inverted control signal.

18. The device of claim 16, wherein the means comprises a control register having a bit that is set when the control signal is an inverted control signal.

19. The device of claim 16, wherein the means comprises an inverter.

20. The device of claim 16, wherein the memory device is a double data rate DRAM.

21. The device of claim 20, wherein the control input comprises an input to a command/address bus.
